(19) United States
(12) Patent Application Publication
(10) Pub. No.: US 2021/0140237 A1
(43) Pub. Date: May 13, 2021

(54) Wallsaver

(71) Applicant: Robert P. Hagen, Clemmons, NC (US)

(72) Inventor: Robert P. Hagen, Clemmons, NC (US)

(21) Appl. No.: 17/080,003

(22) Filed: Oct. 26, 2020

Related U.S. Application Data
(60) Provisional application No. 62/931,837, filed on Nov. 7, 2019.

(51) Int. Cl. E06C 7/48; E06C 7/50

(52) U.S. Cl. CPC E06C 7/48; E06C 7/50

(57) ABSTRACT

The invention relates generally to an apparatus for attachment to a ladder, which allows placement of the ladder against a variety of surfaces without damaging the surface. It also has features which allow the ladder to be used more safely.

### CROSS-REFERENCE TO RELATED APPLICATIONS

This application claims priority benefit of U.S. Provisional Patent Application No. 62/931,837, filed Nov. 7, 2019, the entire contents of which are fully incorporated herein by reference.

### BACKGROUND OF THE INVENTION

The invention relates generally to an apparatus for attachment to a ladder, which allows placement of the ladder against a variety of surfaces without damaging the surface. It also has features which allow the ladder to be used more safely, for example by allowing the ladder to be secured to a surface or wall, or by providing a non-slip surface for placement against the surface.

When traditional ladders are placed against a wall for support during use, it is not uncommon for the ladder to damage the surface where the top of the ladder contacts the wall or other surface for support. Ladder stabilizers or other devices fail to fully distribute the weight of the ladder and user such that damage can be avoided.

A need exists for an apparatus that would allow a ladder bearing the weight of a user to be placed against a variety of surfaces without damaging the surface. Herein is disclosed an apparatus which provided those benefits.

### SUMMARY OF THE INVENTION

In one aspect, the invention relates to a wallsaver for use with a ladder, the wallsaver comprising a substantially planar member that is at least as wide as a ladder with which it is intended to be used, and at least one ladder attachment member, wherein the substantially planar member is pivotally attached to the at least one ladder attachment member, and wherein the at least one ladder attachment member is configured to receive an upper end of a ladder rail.

In some embodiments, the substantially planar member is constructed of a material selected from plastic, aluminum, or steel. In some embodiments, the substantially planar member is constructed of plastic or aluminum.

In some embodiments, the substantially planar member further comprises a pad on a side which contacts a support surface. In some embodiments, the pad comprises rubber.

In some embodiments, the at least one ladder attachment member comprises two sleeves, each of which receive one side rail of the ladder.

In some embodiments, the at least one ladder attachment member further comprises at least one bracket attached to the substantially planar member and pivotally attached to at least one sleeve that receives at least one ladder side rail.

In some embodiments, the at least one ladder attachment member comprises two brackets that are attached to two sleeves that each receive a ladder side rail.

In some embodiments, the substantially planar member comprises one or more fastener openings for securing the substantially planar member to a wall surface. In some embodiments, the one or more fastener openings are spaced apart based on standard spacing of construction studs. In some embodiments, the substantially planar member comprises two slots, a long dimension of which is parallel to a long dimension of the substantially planar member, for attaching each of the two brackets such that the wallsaver is capable of attachment to ladders of varying width.

In one aspect, the invention relates to a wallsaver for use with a ladder, the wallsaver comprising a substantially planar member comprising plastic and a rubber pad on a side positioned to contact a surface and having holes for stud location and for mounting of a ladder attachment member, wherein the substantially planar member is at least as wide as a ladder with which it is intended to be used, and two ladder attachment members, each comprising a brackets for attachment to the substantially planar member and a sleeve pivotally attached to the bracket and adapted for receiving a ladder rail.

### BRIEF DESCRIPTION OF THE DRAWINGS

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1 is a perspective view of one embodiment of the wallsaver as disclosed herein, attached to a ladder as in use.

FIG. 2 is a more detailed view as in FIG. 1, showing one embodiment of the wallsaver as disclosed herein, attached to a ladder.

FIG. 3 is a perspective view of the side of substantially planar member of one embodiment of the wallsaver as disclosed herein, showing a pad on the side of the member that contacts a wall or other flat surface when in use.

FIG. 4 is a side view of one embodiment of the wallsaver as disclosed herein, showing pivotal attachment to a ladder and a padded surface for contacting a wall or other flat surface.

FIGS. 5A-5C are a perspective view (FIG. 5A), cross-sectional view (FIG. 5B), and a back plan view (FIG. 5C) of the substantially planar member of one embodiment of the wallsaver as disclosed herein.

FIG. 6A and FIG. 6B show the relationship of the bracket and sleeve of one embodiment a ladder attachment member of the wallsaver as disclosed herein (FIG. 6A); and the relationship of the bracket to the substantially planar member (FIG. 6B), also as in one embodiment

Various features, aspects, and advantages of the embodiments will become more apparent from the following detailed description, along with the accompanying figures in which like numerals represent like components throughout the figures and text. The various described features are not necessarily drawn to scale but are drawn to emphasize specific features relevant to some embodiments.

The headings used herein are for organizational purposes only and are not meant to limit the scope of the description or the claims. To facilitate understanding, reference numerals have been used, where possible, to designate like elements common to the figures.

### DETAILED DESCRIPTION

The present invention provides a device, a wallsaver attachment, which allows ladders to be placed against a supporting surface without damaging the surface and while allowing safe use of the ladder. This provides a benefit by avoiding damage and associated repair costs, as well as providing a safe method of using the ladder on a variety of surfaces in many applications.

Particularly for interior finish jobs, where ladders will be placed against drywall surfaces, finished or unfinished, ladders can damage the walls by creating indentations in the drywall or sheetrock. The ends of the ladder rails simply do not distribute the weight of the ladder and user sufficiently to prevent this from happening. The wallsaver as disclosed herein prevents ladder damage to sheetrock walls, stucco, aluminum and vinyl siding, vinyl shake, and gutters. The wallsaver is also useful in protecting the surfaces of recreational vehicles, boats, airplanes or any other structure having a surface in need of protection from ladder dents and scratches.

Reference will now be made in detail to various embodiments. Each example is provided by way of explanation and is not meant as a limitation and does not constitute a definition of all possible embodiments.

For purposes of illustrating features of the embodiments, examples will now be introduced and referenced throughout the disclosure. Those skilled in the art will recognize that these examples are illustrative and not limiting and are provided purely for explanatory purposes.

The present disclosure, in various embodiments, configurations and aspects, includes components, methods, processes, systems and/or apparatus substantially developed as depicted and described herein, including various embodiments, sub-combinations, and subsets thereof. Those of skill in the art will understand how to make and use the present disclosure after understanding the present disclosure. The present disclosure, in various embodiments, configurations and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment,” “some embodiments,” “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Referring now to the drawings illustrating particular embodiments of the invention, in FIG. 1, a perspective view of an example of a wallsaver 10 showing a substantially planar member 20 attached to a brackets 30, which are in turn pivotally attached to ladder sleeves 40. In this embodiment, two sets of brackets 30 and ladder sleeves 40 are shown, one set for each rail of the ladder 50. In some embodiments, the wallsaver 10 may be attached to the ladder 50 by a single sleeve which is configured to accept both rails of the ladder 50, i.e., where the single sleeve is wide enough to accept both ladder rails. In such an embodiment, the sleaves may be attached to the substantially planar member via one or more brackets or a hinge.

In FIG. 2, a close-up perspective view similar to that of FIG. 1 is shown. The pivotal attachment of bracket 30 to sleeve 40 is shown, as is sleeve security pin 60, which extends through sleeve 40 and a ladder rail, and may include a clip, cotter-pin or other device for ensuring that sleeve security pin 60 does not back out.

FIG. 3 is a perspective view of substantially planar member 20 showing pad 70 installed on the side of substantially planar member 20 that contacts a wall or other flat surface when in use, i.e., opposite the side of ladder attachment. FIG. 4 is a side plan view of pad 70, substantially planar member 20, bracket 30, sleeve 40, and ladder 50, also showing sleeve security pin 60.

Regarding substantially planar member 20, FIG. 5A shows a perspective view, FIG. 5B shows an end view, and FIG. 5C shows a front (ladder side) plan view. FIGS. 5A and 5B show lip 80, which runs the entire length of each side of substantially planar member 20 in one embodiment, and imparts rigidity to substantially planar member 20. FIG. 5C shows stud location holes 90 and bracket attachment holes 100. In some embodiments, bracket attachment holes 100 may be round, as shown. In other embodiments, however, slotted openings may be substituted, thereby allowing the brackets 30 to be mounted at variable positions and allowing the use of the wallsaver 10 with ladders of varying width.

Stud locations holes 90 are spaced such that they match typical spacing of constructions studs and allow options for various standard spacing. Using stud location holes 90, the wallsaver 10 may be secured to a wall or flat surface where frequent movement of the ladder 50 is unnecessary and/or increased security of the ladder 50 is particularly important.

FIGS. 6A and 6B show details of one embodiment of a ladder attachment member 35 according to the present invention. FIG. 6A shows a two-component ladder attachment member 35, comprising a sleeve 40 and a bracket 30, as well as fastener hole 120 in sleeve 40 and fastener hole 110 in bracket 30, for pivotal attachment of sleeve 40 and bracket 30. Sleeve ladder attachment hole 130 is shown, for sleeve security pin 60, allowing secure attachment to a ladder rail (a set of two of sleeves 40 and brackets 30 are used in particular embodiments. Sleeve open end 150, for inserting a ladder rail, is also shown. FIG. 6B, shows an example of bracket 30 attached to substantially planar member 20 via bracket fastener hole 140.

In addition to particular embodiments shown in the figures described herein, the substantially planar member 20 can be attached to the ladder 50 in any manner that allows pivoting such that substantially planar member 20 can lie flat against a supporting surface when the ladder 50 is placed against such a surface at a variety of angles. Importantly, the present invention provides for broad distribution of the weight of ladder 50 and a user, such that surfaces like drywall, siding, gutters, etc., are not damaged by the weight of the ladder 50 being applied in a concentrated way over a very limited area of the surface, e.g., at only the tops of the ladder rails or only at the tips of a two-post stabilizer. The wallsaver as disclosed herein avoids damage to surfaces and provides for additional safety of the ladder user.

The wallsaver can be constructed of any suitable rigid material, preferably high-strength plastic or aluminum, although other materials such as steel can be used.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one or more embodiments, configurations, or aspects for the purpose of streamlining the disclosure. The features of the embodiments, configurations, or aspects of the present disclosure may be combined in alternate embodiments, configurations, or aspects other than those discussed above. This method of disclosure is not to be interpreted as reflecting an intention that the present disclosure requires more features than are expressly recited in each claim. Rather, as the following claims reflect, the claimed features lie in less than all features of a single foregoing disclosed embodiment, configuration, or aspect.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

### Examples

Wallsaver

In one embodiment of the invention, the wallsaver has a substantially planar member that is 6 inches by 33 inches, and has a ¾ inch lip at a 90 degree angle to the main surface running the length of each 33 inch side (for greater rigidity). The substantially planar member is ⅜ inch extruded aluminum or, alternatively, a suitably rigid composite, plastic, or steel.

The brackets for attaching the substantially planar member to the ladder rail sleeves are as illustrated herein, with a surface for attachment to the substantially planar member that is 1.5 inches×1.5 inches. A fastener hole is provided for securing the bracket to the substantially planar member. The bracket also comprises two 1.5 inch×2 inch tabs having fastener holes for pivotal attachment to the ladder rail sleeves.

The ladder rails sleeves, or end caps, have one closed end and one open end for insertion of a ladder rail, and are 5 inches in the long dimension, with a cross-section that is 1.25 inches×3.25 inches, as well as a fastener hole for pivotal attachment of the bracket, as shown illustrated herein.

In additional to the foregoing features, this embodiment also includes stud locator holes in the substantially planar member to allow fastener access for studs spaced at 16 inches or 24 inches, from left to right or from right to left. They are located 1 inch from the top lip of the substantially planar member and are 5/16 inches in diameter.

Further, the substantially planar member includes two ¼ inch fastener holes for bracket (or mounting clip) attachment, spaced 9 inches from each end and 2.25 inches from the top edge. The holes are countersunk from the back of the substantially planar member.

What is claimed is:

1. A wallsaver for use with a ladder, the wallsaver comprising:
a) a substantially planar member that is at least as wide as a ladder with which it is intended to be used, and
b) at least one ladder attachment member,
wherein the substantially planar member is pivotally attached to the at least one ladder attachment member, and wherein the at least one ladder attachment member is configured to receive an upper end of a ladder rail.

2. The wallsaver of claim 1, wherein substantially planar member is constructed of a material selected from plastic, aluminum, or steel.

3. The wallsaver of claim 2, wherein the substantially planar member is constructed of plastic or aluminum.

4. The wallsaver of claim 2, wherein the substantially planar member is constructed of plastic.

5. The wallsaver of claim 1, wherein the substantially planar member further comprises a pad on a side which contacts a support surface.

6. The wallsaver of claim 5, wherein the pad comprises rubber.

7. The wallsaver of claim 1, wherein the at least one ladder attachment member comprises two sleeves, each of which receive one side rail of the ladder.

8. The wallsaver of claim 7, wherein the at least one ladder attachment member further comprises at least one bracket attached to the substantially planar member and pivotally attached to at least one sleeve that receives at least one ladder side rail.

9. The wallsaver of claim 8, wherein the at least one ladder attachment member comprises two brackets that are attached to two sleeves that each receive a ladder side rail.

10. The wallsaver of claim 1, wherein the substantially planar member comprises one or more fastener openings for securing the substantially planar member to a wall surface.

11. The wallsaver of claim 10, wherein the one or more fastener openings are spaced apart based on standard spacing of construction studs.

12. The wallsaver of claim 9, wherein the substantially planar member comprises two slots, a long dimension of which is parallel to a long dimension of the substantially planar member, for attaching each of the two brackets such that the wallsaver is capable of attachment to ladders of varying width.

13. A wallsaver for use with a ladder, the wallsaver comprising:
a) a substantially planar member comprising plastic and a rubber pad on a side positioned to contact a surface and having holes for stud location and for mounting of a ladder attachment member, wherein the substantially planar member is at least as wide as a ladder with which it is intended to be used, and
b) two ladder attachment members, each comprising a brackets for attachment to the substantially planar member and a sleeve pivotally attached to the bracket and adapted for receiving a ladder rail.
